(19) United States
(12) Patent Application Publication
(10) Pub. No.: US 2009/0184530 A1
(43) Pub. Date: Jul. 23, 2009

(54) LOCKING ELEMENT FOR ATTACHING A HOUSING OF A HIGH-FREQUENCY DEVICE

(76) Inventor: David Silva, Nürtigen (DE)

Correspondence Address: K.F. ROSS P.C., 5683 RIVERDALE AVENUE, SUITE 203 BOX 900, BRONX, NY, 10471-0900, US

(21) Appl. No.: 12/307,949

(22) PCT Filed: Jun. 18, 2007
(86) PCT No.: PCT/EP07/05336

§ 371 Date: Jan. 8, 2009

(30) Foreign Application Priority Data
Jul. 13, 2006 (DE) 10 2006 032 462.5

(51) Int. Cl. B60R 11/02

(52) U.S. Cl. 296/37.6

(57) ABSTRACT

The invention relates to a locking element (1) for attaching a housing (2) of a high-frequency device of a vehicle to a holder (4). Said locking element (1) can be actuated by means of a tool (8) for removing the device from the holder (4). The inventive locking element (1) is embodied as a planar punched bent part that comprises a first section (11), a second section (13) that forms an angle and adjoins the first section (11), and a locking section (14) adjoining the second section (13).

The invention relates to a latch element for attaching a housing of a high-frequency device of a vehicle to a holder in accordance with the characteristics of claim 1.

Latch elements for attaching a housing of a high-frequency device of a vehicle to a holder, in particular a holder frame, are principally known for car radios, for example, which are inserted into a DIN well. However, the known latch elements are expensive to manufacture. For example, they are shaped in a complex manner in a plurality of planes, with many angles formed on various planes. Because of this complex geometry, the known latch elements are difficult to handle, and expensive because of the tools and production steps required to do so.

Thus, the object of the invention is to provide a latch element for attaching a housing of a high-frequency device of a motor vehicle to a holder, that is of simple design, requires low manufacture and tool costs, and is easy to handle.

The object of the patent is attained with the characteristics of the patent claim 1.

In accordance with the invention, the latch element is a planar punched bent part having a first section, a second section that forms an angle and merges the first section, and a locking section that extends the second section. The planar shape with segments that form sections of opposite angles has the advantage that the latch element is easy to produce because it is known that the latch element in accordance with the invention operates in the same way as known latch elements, but at the same time has a shape that is much less complex than that of known latch elements. In an especially advantageous manner, the sections that are shaped straight and planar succeed one another and thus the latch element can be produced in one punch and bending method without cost-intensive tools. Furthermore, it can also be attached in a simpler manner because one section, preferably the first section, is designed to attach the latch element to the housing of the high-frequency device. To that end, advantageously, rivet or a glue joint is provided, with these connections having the advantage that they can be executed quickly and simply, and that they secure the latch element permanently to the housing. The successive adjoining sections, of which there are at least three, furthermore have the advantage that the latch element is elastically deformable (and thus springy), and thus it is permanently self-biased against the inner surface of the housing and/or the holder after the device is inserted into the holder to avoid the generation of noise caused by vibration during operation. To that end, it is furthermore provided in an advantageous manner that the latch element is comprised of a spring material.

Another advantage of the latch element is the assembly without tools, such that the housing of the device can be inserted into the holder and the latch element locks it to the holder after the device has been completely inserted. Only disassembly, i.e. removing the housing from the holder, requires a simply shaped tool to move the locked latch segment of the latch element into a different position so that the housing can be removed from the holder.

Another advantage of the latch element in accordance with the invention is that it requires less space relative to the known latch elements, and thus less space is required inside the housing of the high-frequency device, allowing for an overall smaller housing while performance remains the same.

An embodiment of a latch element in accordance with the invention is described in the following and explained with reference to the drawing, although the invention is not limited to the latch element.

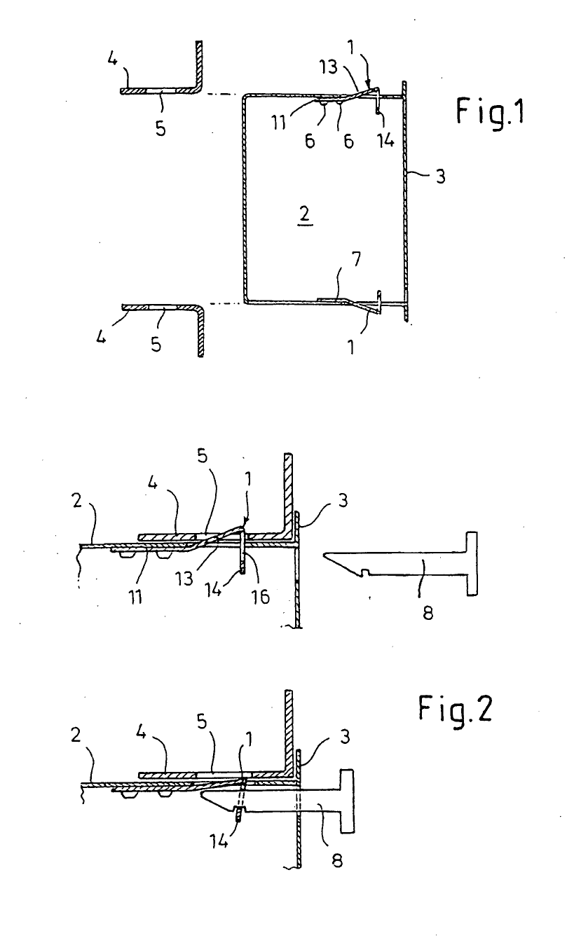

As far as being shown individually, FIGS. 1 to 3 show a latch element at 1. The latch element 1 is preferably attached to the inner surface of a housing 2 of a high-frequency device having a front face 3 (preferably with operating elements and/or display elements) and shown only schematically to clarify the location of the latch element 1 on the housing 2. The housing 2 can fit into a holder 4, preferably an annular frame, with the holder 4 formed with at least one aperture 5 to lock the housing 2 in position by means of the latch element 1. The example in FIG. 1 shows that the latch element 1 is fixed on the housing 2 by a rivets 6 and/or a glue joint 7. These two connection methods are mere examples, and thus other systems for fastening the latch element 1 on the housing 2 are conceivable. It is also conceivable, depending on the shape of the housing 2 and the corresponding holder 4, to attach the latch element 1 not on the inside surface of the housing 2, but on its outer surface. Furthermore, there are preferably two latch elements arranged symmetrically on an outer wall of the housing 2, but it is also conceivable, depending on the size of the housing 2, to use only one latch element 1 or more than two latch elements 1.

In the upper view, FIG. 2 shows the situation where the housing 2 is completely inserted into the holder 4. The angled locking section of the latch element 1 engages into the aperture 5 of the housing 2 and, because of its approximately right-angled shape, prevents the housing 2 from being pulled out of the holder 4. This requires the use of a simply shaped tool 8 that, because of its shape and how it fits with the latch element 1, pulls the angled end section of the latch element 1 out of the aperture 5 far enough that the angled section is no longer in the aperture 5 of the holder 4 and thus the locking action of the latch element 1 is released and the housing 2 can be pulled out of the holder 4.

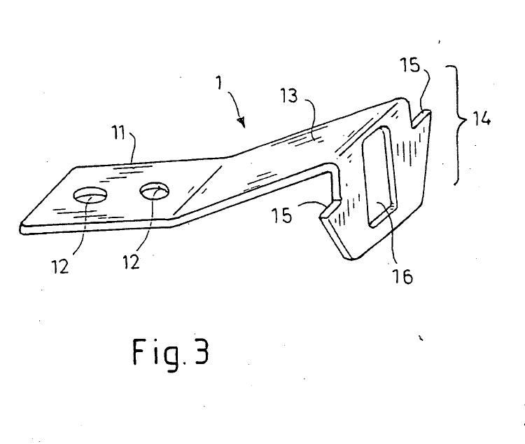

FIG. 3 shows the exact shape of the latch element 1, with the longitudinal and planar shape and the adjoining sections being shown. A first, preferably flat rectangular section 11 has at least two holes 12, used when the latch element 1 is attached to the housing 2 by rivets 6. If the latch element 1 is supposed to be attached to the housing 2 by a glue joint, there may be the holes 12, but, preferably, they are omitted. The first section 11 merges into an angled second section 13 that in turn merges with an angled locking section 14 that has a special shape to do its job. The locking section 14 is of increased width at its outer end, thus forming a shoulder 15 (in particular two symmetrical shoulders 15). These shoulders 15 project laterally past the aperture 5 when the latch element 1 locks the housing 2 in the holder 4. Furthermore, there is an elongated slot 16 in the locking section 14 that cooperates with the slanted end face of the tool 8 (see FIG. 2). For spring action when the locking section 15 extends into the aperture 5, the first section 11 forms an obtuse angle with the second section 13. Instead of an angle, an arcuate shape is also conceivable, with the first section 11 merging into the second section 13. The same applies for the transition from the second section 13 to the locking section 14, which can also be angular, arcuate or another shape. To get the locking effect of the latch element 1, the angle formed between the locking section 15 and the second section 13 is sharper than the angle formed between the second section 14 and the first section 11. The acute angle formed between the second section 13 and the locking section 14 ensures that when latched, i.e. when the housing 2 is completely inserted into the holder 4, the locking section 14 forms with the outer surface of the housing 2 and/or the wall of the holder 4 an approximately right angle. This creates the locking effect, which can be lifted by means of the tool when the angled cam face of the tool 8 is inserted into the slot 16.

In addition to the simple shape of the latch element 2 as is shown in FIG. 3, for example, the corresponding simple shape of the tool 8 is also essential, and the tool 8 is also simple to handle and cost effective. The tool 8 is also comprised of a flat material, and is also produced in a punch-and-bend method. Likewise, it should also be pointed out that it is important that the housing 2 be secured in the holder 4 without tools by means of the latch element 1, and thus the use of a tool is required only for removal.

### LIST OF REFERENCE SYMBOLS

1. Latch element
2. Housing
3. Front side
4. Holder
5. Aperture
6. Riveted joint
7. glue joint
8. Tool
11. First section
12. Holes
13. Second section
14. Locking section
15. Shoulder
16. Slot

1-7. (canceled)

8. In combination with an annular holder frame formed with an aperture and with a high-frequency device having a housing fittable in the frame, a latch assembly comprising:
a one-piece latch element having a first flat section engaging the housing, a second section extending longitudinally from the first section and forming a first angle therewith, and a third section extending longitudinally from the second section at a second angle thereto; and
means for fixing the first section to the housing with the second and third sections projecting laterally from the housing at a position engageable in the aperture when the housing is fitted to the frame.

9. The combination defined in claim 8 wherein the first section is formed with at least one throughgoing hole, the means for fixing being a rivet extending through the hole.

10. The combination defined in claim 8 wherein the means for fixing is a glue joint.

11. The combination defined in claim 8 wherein the third section has a shoulder that normally bears on an inner surface of the housing.

12. The combination defined in claim 8 wherein the second angle is more acute than the first angle.

13. The combination defined in claim 8 wherein the latch element is made of spring material.

14. The combination defined in claim 8 wherein the high-frequency device is a vehicle GPS system, antenna amplifier, or television tuner.

15. In combination with an annular holder frame formed with an aperture and with a high-frequency device having a housing fittable complementarily in the frame and itself formed with a throughgoing opening, a latch assembly comprising:
a one-piece latch element made of rigid but elastically deformable material and having a first flat section engaging an inner surface of the housing adjacent the opening of the housing, a second section extending at a first angle longitudinally from the first section through the opening and outside the housing, and a third section extending at a second angle from the second section back into the housing at a generally right angle to the housing; and
means for fixing the first section to the inner surface housing with the second and third sections projecting laterally from the opening of the housing at a position engageable in the aperture when the housing is fitted to the frame.

16. The combination defined in claim 15 wherein the first angle is a large obtuse angle and the second angle is an oppositely directed acute angle.

17. The combination defined in claim 15 wherein the first and third sections are planar.

18. The combination defined in claim 17 wherein the third section is formed with a throughgoing hole, the housing of the device also being formed in line with the opening of the housing with a window aligned with the third section of the latch element, the combination further comprising:
a removal tool fittable through the window of the housing and having an angled end engageable in the hole of the third section to cam the second and third sections into the housing and pull them out of engagement with the aperture of the frame.

19. The combination defined in claim 18 wherein the latch element is formed of spring material.

20. The combination defined in claim 20 wherein the third section is formed with an outwardly directed shoulder normally bearing with spring force against the inner surface of the housing at an edge of the opening of the housing.
